(19) United States
(12) Patent Application Publication
(10) Pub. No.: US 2019/0089754 A1
(43) Pub. Date: Mar. 21, 2019

(54) SYSTEM AND METHOD FOR PROVIDING AUDIO CONFERENCE BETWEEN HETEROGENIOUS NETWORKS

(71) Applicant: SAMSUNG SDS CO., LTD., Seoul (KR)

(72) Inventors: Hee-Tae YOON, Seoul (KR); Do-Hyung IM, Seoul (KR); Jun-Ho KANG, Seoul (KR); Seong-Joong CHANG, Seoul (KR)

(73) Assignee: SAMSUNG SDS CO., LTD., Seoul (KR)

(21) Appl. No.: 16/134,166

(22) Filed: Sep. 18, 2018

(30) Foreign Application Priority Data
Sep. 18, 2017 (KR) 10-2017-0119387

(51) Int. Cl. H04L 29/06; H04M 3/56; H04L 12/66

(52) U.S. Cl. CPC H04L 65/4053; H04L 12/66; H04M 3/56; H04L 65/1063

(57) ABSTRACT

A system and method for providing an audio conference between heterogeneous networks are provided. The system for providing an audio conference according to one embodiment of the present disclosure includes an audio conference server configured to relay an audio conference between a plurality of terminals; and a web conference server configured to receive a request of a host terminal for connection to the audio conference and create a first bridge session for audio data transmission/reception between the host terminal and the audio conference server and a second bridge session for maintaining a host connection of the host terminal.

### CROSS-REFERENCE TO RELATED APPLICATION(S)

This application claims the benefit under 35 USC § 119(a) of Korean Patent Application No. 10-2017-0119387, filed on Sep. 18, 2017, in the Korean Intellectual Property Office, the entire disclosure of which is incorporated herein by reference for all purposes.

### BACKGROUND

### 1. Field

The following description relates to a technology for providing an audio conference between heterogeneous networks.

### 2. Description of Related Art

An audio conference system is a remote communication system in which two or more users access a virtual conference room using phones and simultaneously conduct a conference using voice. By participating in the audio conference, people at multiple locations can conveniently collaborate using phones.

A conventional audio conference is typically conducted through a public switched telephone network (PSTN). However, in recent years, as the use of Internet protocol (IP)-based packet networks, such as the Internet, has become common and technologies for providing voice communications in packet networks, such as Voice over IP (VoIP), have been introduced, attempts have been increasingly made to improve user convenience by combining the conventional conference and the VoIP technology.

There are two main approaches to accessing an audio conference using VoIP. The first approach is that a terminal accesses the audio conference through a session order controller (SBC) of an audio conference system using a session initiation protocol (SIP) and the second approach is that a bridge is configured between a web conference system and an audio conference system using a bridge server and a terminal connects to the web conference system to communicate with the audio conference system through the bridge.

In the first approach, significant costs are incurred to build an infrastructure for a SIP-based VoIP connection in the audio conference system. This is because pieces of equipment, such as a signal gateway for SIP signal processing, a media gateway for individual media processing, an SBC for processing connection of individual terminals and the like, need to be provided to enable individual terminals to directly connect to an audio conference server, and all terminals must use such equipment.

The second approach can be implemented without separate equipment for SIP, and thus communication cost between a web conference server and a client is rarely incurred. In addition, a bridge server which mixes and transmits the voices of multiple participants utilizes only SIP server equipment which corresponds to one call, thereby significantly reducing the costs.

However, in the case of the second approach, when a host of the audio conference accesses the audio conference through a web conference and the bridge server using a VoIP method, a session with the bridge server is recognized as a host. Therefore, when the host reconnects to the audio conference in a PSTN network after terminating a connection to the web conference, the audio conference ends the connection with the bridge session, and accordingly, a connection of a general participant terminal which is participating in the audio conference through the bridge session is also terminated.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide a technical means for providing a seamless audio conference service for users regardless of a type of network which the users wish to access, such as Voice over Internet (VoIP) or a public switched telephone network (PSTN).

In one general aspect, there is provided a conference system including: an audio conference server configured to relay an audio conference between a plurality of terminals; and a web conference server configured to receive a request of a host terminal for connection to the audio conference and create a first bridge session for audio data transmission/reception between the host terminal and the audio conference server and a second bridge session for maintaining a host connection of the host terminal.

When the web conference server receives a request for connection to the audio conference from a general participant terminal, the web conference server may transmit respective audio data of the host terminal and the general participant terminal connected to the web conference server to the audio conference server via the first bridge session.

The web conference server may transmit audio data received from the audio conference server via the first bridge session to the host terminal and the general participant terminal.

When the audio conference server may receive a request for reconnection to the audio conference from the host terminal through a telephone network, the audio conference server may terminate a connection to the second bridge session.

In another general aspect, there is provided a web conference server which is connected to an audio conference server that relays an audio conference between a plurality of terminals, the web conference server including: a receiver configured to receive a request of a host terminal for connection to an audio conference; a bridge session creator configured to create a first bridge session for audio data transmission/reception between the host terminal and the audio conference server and a second bridge session for maintaining a host connection of the host terminal according to the request; and a data transceiver configured to transmit and receive audio data between the host terminal and the audio conference server through the first bridge session.

When the receiver receives a request for connection to the audio conference from a general participant terminal, the data transceiver may transmit respective audio data of the host terminal and the general participant terminal to the audio conference server via the first bridge session.

The data transceiver may transmit audio data received from the audio conference server via the first bridge session to the host terminal and the general participant terminal.

When the host terminal reconnects to the audio conference server through a telephone network, the second bridge session may be terminated.

In still another general aspect, there is provided a method for providing a conference service, including: receiving, at a web conference server, a request of a host terminal for connection to an audio conference; and creating, at the web conference server, a first bridge session for audio data transmission/reception between the host terminal and an audio conference server in which the audio conference is established and a second bridge session for maintaining a host connection of the host terminal.

When the web conference server receives a request for connection to the audio conference from a general participant terminal, the web conference server may transmit respective audio data of the host terminal and the general participant terminal to the audio conference server via the first bridge session and transmit audio data received from the audio conference server via the first bridge session to the host terminal and the general participant terminal.

The method may further include, after creating the first and second bridge sessions, receiving, at the audio conference server, a request for reconnection to the audio conference from the host terminal through a telephone network; and terminating, at the audio conference server, a connection to the second bridge session.

In yet another general aspect, there is provided a conference system including: an audio conference server configured to relay an audio conference between a plurality of terminals; and a web conference server configured to create a bridge session for audio data transmission/reception with the audio conference in cooperation with the audio conference server, wherein when the web conference server receives a request of a host terminal for connection to an audio conference, the web conference server transmits a redirection message for reconnection to the audio conference server to the host terminal.

When the web conference server receives a request for connection to the audio conference from a general participant terminal, the web conference server may transmit audio data of the general participant terminal to the audio conference server via the bridge session and transmit audio data received from the audio conference server via the bridge session to the general participant terminal.

In yet another general aspect, there is provided a method for providing a conference service, which is performed by a web conference server that creates a bridge session for audio data transmission/reception with an audio conference in cooperation with an audio conference server which relays the audio conference between a plurality of terminals, the method including: receiving a request of a host terminal for connection to the audio conference; and transmitting a redirection message for reconnection to the audio conference server to the host terminal.

When the web conference server receives a request for connection to the audio conference from a general participant terminal, the web conference server may transmit audio data of the general participant terminal to the audio conference server via the bridge session and transmit audio data received from the audio conference server via the bridge session to the general participant terminal.

Other features and aspects will be apparent from the following detailed description, the drawings, and the claims.

### BRIEF DESCRIPTION OF THE DRAWINGS

FIG. 1 is a block diagram for describing a conference system 100 according to one embodiment of the present disclosure.

FIG. 2 is a block diagram for describing an example in which a host terminal connects to a web conference server in a conference system according to one embodiment of the present disclosure.

FIG. 3 is a block diagram for describing an example in which a host terminal terminates a connection to a web conference server and reconnects to an audio conference server in a conference system according to one embodiment of the present disclosure.

FIG. 4 is a flowchart for describing an example in which a host terminal reconnects to an audio conference server while conducting an audio conference by connecting to a web conference server in a conference system according to one embodiment of the present disclosure.

FIG. 5 is a block diagram for describing a web conference server according to one embodiment of the present disclosure.

FIG. 6 is a block diagram for describing an example method for a host terminal to connect to an audio conference in a conference system according to another embodiment of the present disclosure.

FIG. 7 is a flowchart for describing a method for a host terminal to connect to an audio conference in a conference system according to another embodiment of the present disclosure.

FIG. 8 is a block diagram for describing an example of a computing environment including a computing device suitable to be used in exemplary embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

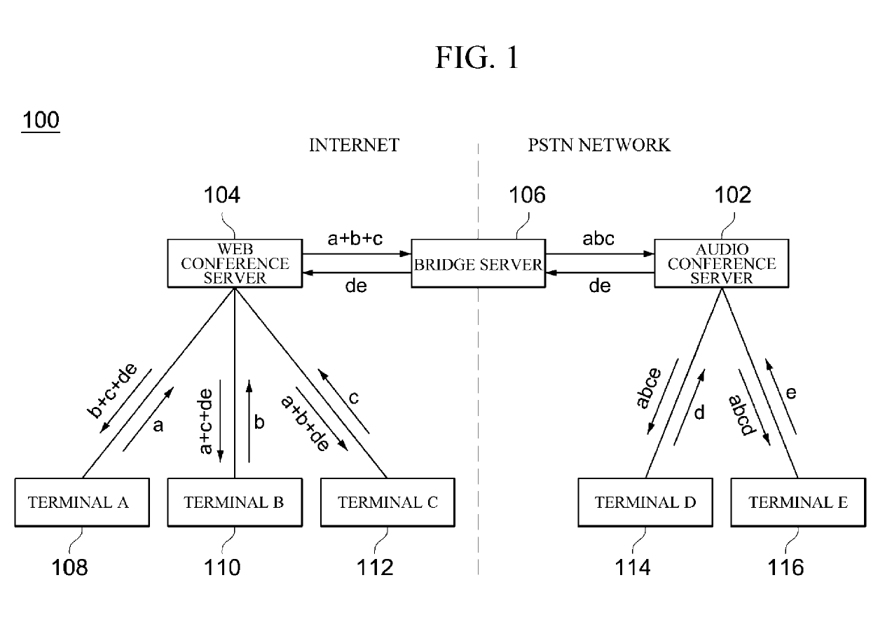

FIG. 1 is a block diagram for describing a conference system 100 according to one embodiment of the present disclosure. As shown in FIG. 1, the conference system 100 includes an audio conference server 102, a web conference server 104, a bridge server 106, and a plurality of terminals 108, 110, 112, 114, and 116. In the illustrated embodiment, five terminals including terminal A 108, terminal B 110, terminal C 112, terminal D 114, and terminal E 116 take part in a conference, but embodiments of the present disclosure are not limited to a specific number of terminals.

The audio conference server 102 is a server for providing an audio conference service among the plurality of terminals 108, 110, 112, 114, and 116. In one embodiment, the audio conference server 102 establishes an audio conference and relays audio data between the terminals taking part in the established audio conference. In embodiments of the present disclosure, the audio conference server 102 provides the audio conference service via a public switched telephone network (PSTN). In addition, the audio conference server 102 may also provide an interface accessible using session initiation protocol (SIP)-based Voice over Internet Protocol (VoIP) technology. In this case, a user may be able to connect to the audio conference server 102 using an SIP-based terminal.

The web conference server 104 provides the audio conference service to the terminals 108, 110, and 112 connected to the web conference server 104 in cooperation with the audio conference server 102. In the embodiments of the present disclosure, the web conference server 102 may be connected to the accessing terminals 108, 110, and 112 using VoIP in a packet communication network and enable the terminals 108, 110, and 112 to join the audio conference. In some embodiments, the communication network may include the Internet, one or more local area networks, wide area networks, cellular networks, mobile networks, other types of networks, and combinations thereof.

The bridge server 106 is a server to relay data transmission/reception between the audio conference server 102 and the web conference server 104. In one embodiment, upon request from the web conference server 104, the bridge server 106 may create a bridge session for data transmission and reception to and from the audio conference server 102 and the web conference server 104. The bridge server 106 receives voice data of the terminals 108, 110, and 112, which connect to the web conference server 104, from the web conference server 104 through the bridge session, synthesizes the received voice data, and transmits the synthesized voice data to the audio conference server 102. In addition, the bridge server 106 receives voice data of the terminals 114 and 116, which connects to the audio conference server 102, from the audio conference server 102 through the bridge session and transmits the same to the web conference server 104. In the embodiments of the present disclosure, the bridge server 106 may be included as one element within the audio conference server 102 or the web conference server 104 or may be implemented as a hardware device separate from the audio conference server 102 or the web conference server 104.

The terminals 108, 110, 112, 114, and 116 are devices used to participate in the audio conference established in the audio conference server 102. In one embodiment, the terminals 108, 110, 112, 114, and 116 may be devices having a PSTN-based voice call function, devices having a VoIP-based voice call function in a packet network, or devices supporting the two types of voice call functions. For example, in the case of devices having a PSTN-based voice call function, such as terminal D 114 and terminal E 116, the devices directly connect to the audio conference server 102 and participate in the audio conference. In the case of devices having a VoIP-based voice call function, such as terminal A 108, terminal B 110, and terminal C 112, the devices may participate in the audio conference via the web conference server 104 and the bridge server 106 in the packet network. In addition, when the audio conference server 102 also provides an interface accessible using SIP-based VoIP technology, terminal A 108, terminal B 110, and terminal C 112 may directly connect to the audio conference server 102 through a SIP-based VoIP client.

Meanwhile, at least some terminals may be devices supporting both the PSTN scheme and the VoIP scheme. In this case, the terminals may connect to either the audio conference server 102 or the web conference server 104 according to the type of network that is currently accessible and join the audio conference. In addition, the terminals supporting both the PSTN scheme and the VoIP scheme may switch the current accessing network to another network when a connection environment is changed during the participation in the audio conference. For example, when terminal C 112 supports both the PSTN scheme and the VoIP scheme, terminal C 112 may connect to the web conference server 104 and reconnect to the audio conference server 102 while participating in the audio conference, so as to continue the audio conference.

In the embodiment illustrated in FIG. 1, terminal A 108, terminal B 110, and terminal C 112 connect to the web conference server 104 and terminal D 114 and terminal E 116 connect to the audio conference server 116. In FIG. 1 and the following drawings, lower case letters denote audio data transmitted from corresponding terminals. For example, ‘a’ denotes audio data transmitted from terminal A 108. In addition, two or more letters attached to each other represent audio data obtained by synthesizing corresponding audio data each other. For example, letters “ab” represents audio data obtained by synthesizing audio data a of terminal A 108 and audio data b of terminal B 110. On the other hand, two letters connected with a plus symbol (+) indicate that each audio data is transmitted as a separate stream. For example, an expression “a+b” indicates that audio data a of terminal A 108 and audio data b of terminal B 110 are transmitted as separate streams.

In the illustrated embodiment, each of the terminals 108, 110, 112, 114, and 116 transmits their respective audio data a, b, c, d, and e to the server which they connect to. For example, terminal A 108, terminal B 110, and terminal C 112, which connect to the web conference server 104, transmit their respective audio data a, b, and c to the web conference server 104. In addition, terminal D 114 and terminal E 116, which connect to the audio conference server 102, transmit their respective audio data d and e to the audio conference server 102.

The web conference server 104 transmits each of the received audio data a, b, and c (a+b+c) to the bridge server through the bridge session created in the bridge server 106. Then, the bridge server 106 synthesizes the received audio data and transmits the synthesized audio data (abc) to the audio conference server 102. The reason why the audio data are synthesized in the bridge session and the synthesized audio data is transmitted to the audio conference server 102 is that the audio conference server 102 recognizes the bridge session as if the bridge session was one terminal participating in the audio conference through a SIP-based VoIP interface. The audio conference server 102 which has received the synthesized audio data synthesizes the received audio data and the audio data of each of terminal D 114 and terminal E 116 which connect to the audio conference server 102 and transmits the synthesized data to terminal D 114 and terminal E 116. Specifically, a synthetic signal abce of audio data abc and audio data e and a synthetic signal abcd of audio data abc and audio data d are transmitted to terminal D 114 and terminal E 116, respectively.

Meanwhile, the audio conference server 102 transmits a signal (de) obtained by synthesizing respective audio data d and e received from terminal D 114 and terminal E 116 to the web conference server 104 through the bridge session. Then, the web conference server 104 transmits the received synthesized data and the audio data of each of terminal A 108, terminal B 110, and terminal C 112 to the terminals that connect to the web conference server 104. Specifically, the respective audio data of terminal B 110 and terminal C 112 and the synthesized audio data (b+c+de) are transmitted to terminal A 108, the respective audio data of terminal A 108 and terminal C 112 and the synthesized audio data (a+c+de) are transmitted to terminal B 110, and the respective+e audio data of terminal A 108 and terminal B 110 and the synthesized audio data (a+b+de) are transmitted to terminal C 112.

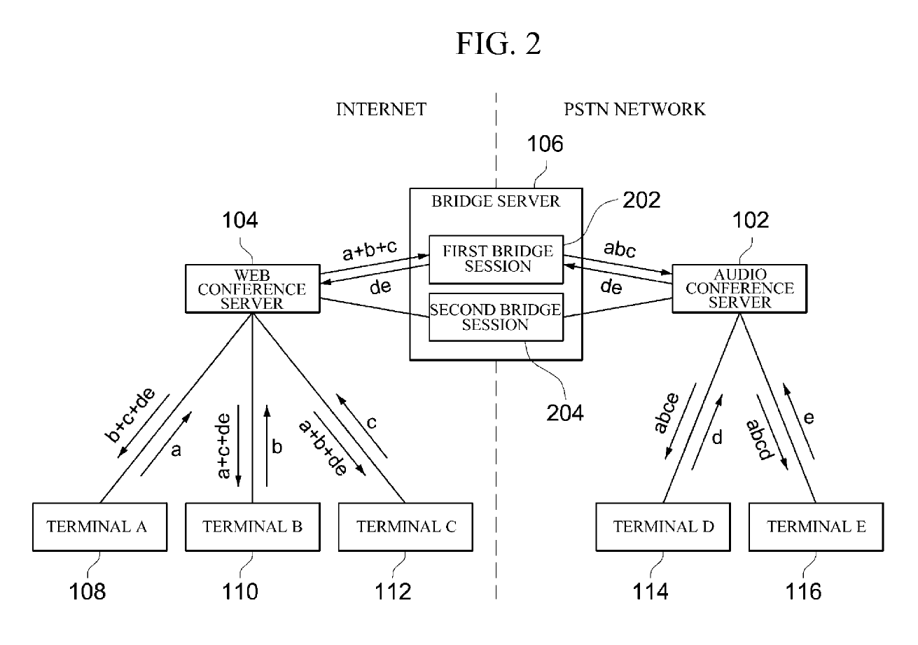

FIG. 2 is a block diagram for describing an example in which a host terminal connects to a web conference server 104 in a conference system according to one embodiment of the present disclosure.

An audio conference, by its nature, has a concept of host. A host is a conference organizer that establishes an audio conference and pays a fee for the established audio conference. That is, the audio conference established by the host proceeds only when the host, which is the conference organizer, is connected, and the corresponding audio conference ends when the host terminates the connection.

Accordingly, the audio conference server 102 retains information on which terminal is a host terminal among terminals participating in the audio conference, and when the corresponding terminal terminates the connection, the audio conference server 102 terminates the audio conference. When the host is connected to the audio conference via the web conference server 104, the audio conference server 102 recognizes a bridge session created between the audio conference server 102 and the web conference server 104 as a host. In this case, when the host terminates the connection to the web conference server 104 and reconnects to the audio conference server 102, the audio conference server 102 terminates the connection with the bridge session, which has been previously recognized as a host, and accordingly, the connections of the other terminals participating in the audio conference through the corresponding bridge session are also terminated.

For example, when terminal C 112 is a host in the embodiment illustrated in FIG. 2 and terminal C 112 terminates the connection to the web conference server 104 and reconnects to the audio conference server 102, the audio conference server 102 terminates the connection to the bridge session, which has been previously recognized as a host, so that connections of terminal A 108 and terminal B 110 which are participating in the audio conference through the corresponding bridge session are also ended.

To solve such a problem, in the present embodiment, when the web conference server 104 receives an audio conference connection request from a host terminal (terminal C 112 in FIG. 2), the web conference server 104 is configured to create two bridge sessions including a first bridge session 202 and a second bridge session 204. The first bridge session 202 performs the above-described original function of the bridge session, that is, audio data transmission/reception between the audio conference server 102 and the web conference server 104. In addition, the second bridge session 204 does not relay audio data and is used to maintain a host connection of the host terminal. That is, the audio conference server 102 recognizes the second bridge session 204 created separately from the first bridge session 202 as a host of the corresponding audio conference.

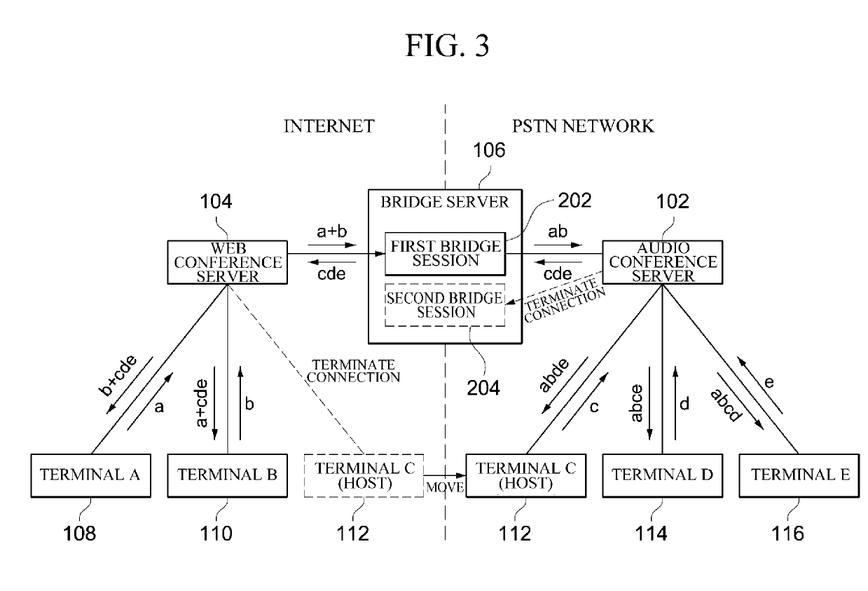

FIG. 3 is a block diagram for describing an example in which a host terminal terminates a connection to a web conference server 104 and reconnects to an audio conference server 102 in a conference system 100 according to one embodiment of the present disclosure.

For example, it is assumed that terminal C 112 service as a host terminal cannot maintain a connection to the web conference server 104 during an audio conference due to moving to another place or any other reasons. In this case, terminal C 112 ends the connection to the web conference server 114 and reconnects to the audio conference server 102. Then, the audio conference server 102 terminates a connection to a second bridge session 204, which has been previously recognized as a host. However, relay of audio data between the web conference server 104 and the audio conference server 102 is performed through a first bridge session 202 other than the second bridge session 204, and thus terminal A 108 and terminal B 110 which have been connected to the web conference server 104 are allowed to continue the audio conference without being affected by the termination of the connection of terminal C 112 to the web conference server 104 and the reconnection to the audio conference server 102.

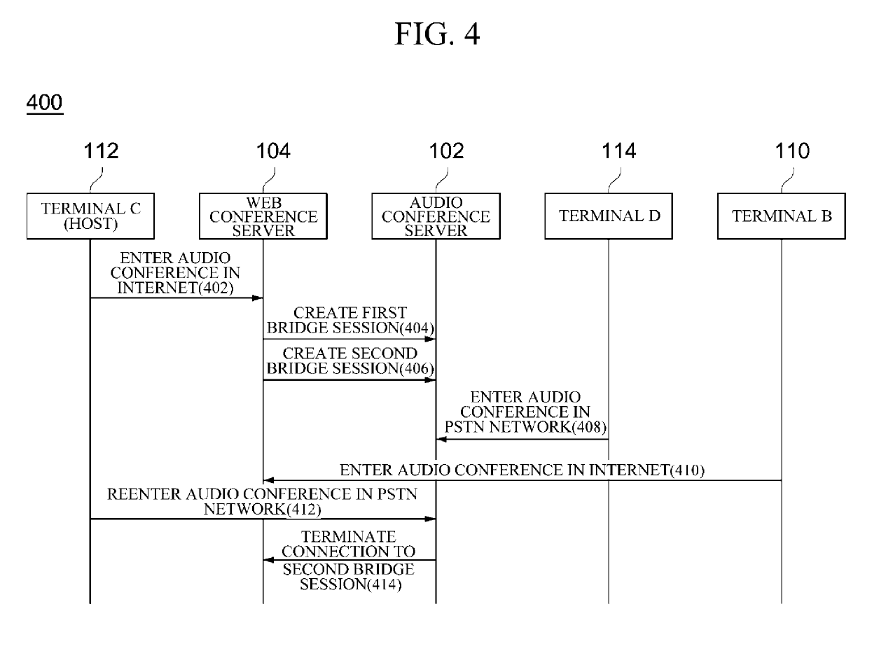

FIG. 4 is a flowchart for describing an example method 400 in which a host terminal reconnects to an audio conference server 102 while conducting an audio conference by connecting to a web conference server 104 in a conference system 100 according to one embodiment of the present disclosure. In the illustrated flowchart, the method is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

In operation 402, terminal C 112, which is a host terminal, issues an audio conference connection request to the web conference server 104 in a packet network.

In operation 404, the web conference server 104 creates a first bridge session 202 in a bridge server 106. The first bridge session 202 is a bridge session for audio data transmission/reception between terminal C 112 and the audio conference server 102.

In operation 406, the web conference server 104 creates a second bridge session 204 in the bridge server 106. The second bridge session 204 is a session for maintaining a host connection of terminal C 112, and the audio conference server 102 recognizes the second bridge session 204 as a host.

In operation 408, the audio conference server 102 receives an audio conference connection request from a PSTN terminal (e.g., terminal D 114) and processes an audio conference connection of the corresponding terminal.

In operation 410, the web conference server 104 receives an audio conference connection request from a VoIP terminal (e.g., terminal B 110) and processes an audio conference connection of the corresponding terminal. In this case, the web conference server 104 may transmit audio data of terminal C 112 serving as a host terminal and audio data of terminal B 110, which is a general participant terminal, to the audio conference server 102 via the first bridge session 202. In addition, the web conference server 104 may transmit audio data of terminal D 114, which is received from the audio conference server 102 via the first bridge session 202, to terminal C 112 serving as a host terminal and terminal B 110, which is a general participant terminal.

In operation 412, the audio conference server 102 receives a request for reconnection to the audio conference from terminal C 112, which is a host terminal, through a telephone network.

In operation 414, the audio conference server 102 terminates a connection to the second bridge session 204, which has been previously recognized as a host. As described above, in this case, audio data transmission/reception of terminal B 110 is still performed through the first bridge session 202, and thus is not affected by the connection termination and reconnection of terminal C 112.

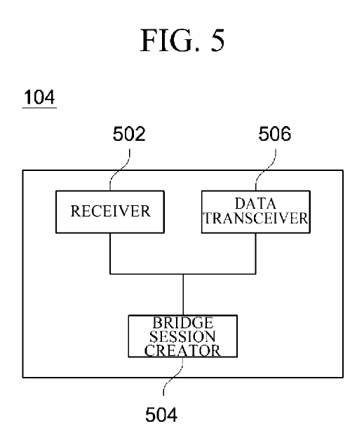

FIG. 5 is a block diagram for describing a web conference server 104 according to one embodiment of the present disclosure. The web conference server 104 according to one embodiment of the present disclosure is a server connected to an audio conference server 102, which relays an audio conference between a plurality of terminals, and includes a receiver 502, a bridge session creator 504, and a data transceiver 506, as shown in FIG. 5.

The receiver 502 receives an audio conference connection request of a host terminal 112.

The bridge session creator 504 creates a first bridge session 202 and a second bridge session 204 which are linked to the audio conference server 102 according to the audio conference connection request of the host terminal 112.

The data transceiver 506 transmits and receives audio data between the host terminal 112 and the audio conference server 102 through the first bridge session 202. When the receiver 502 receives a request for connection to the audio conference from any of general participant terminals 108 and 110, the data transceiver 506 may transmit respective audio data of the host terminal 112 and the general participant terminals 108 and 110 to the audio conference server 102 via the first bridge session 202 and transmit audio data, which is received from the audio conference server 102 via the first bridge session 202, to the host terminal and the general participant terminals 108 and 110.

Meanwhile, the second bridge session 204 is terminated when the host terminal 112 reconnects to the audio conference through a telephone network.

According to the disclosed embodiments, even when the host of the audio conference reconnects to the web conference in a PSTN network after connecting to the audio conference through a web conference and the bridge server using a VoIP method, general participants who have joined the audio conference using the VoIP method are allowed to continue the audio conference without any influence, such as loss of connection to the audio conference.

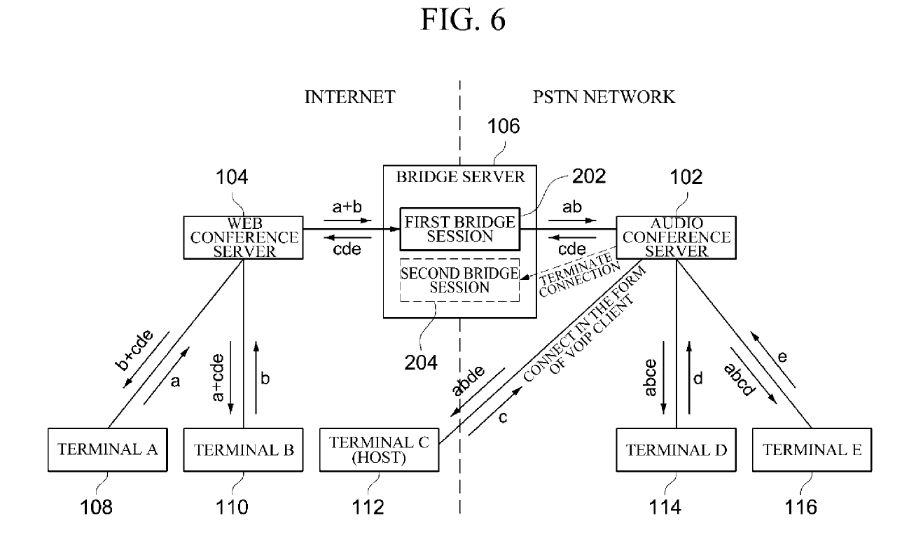

FIG. 6 is a block diagram for describing an example method for a host terminal to connect to an audio conference in a conference system 100 according to another embodiment of the present disclosure.

As described above, there are three methods for terminals 108, 110, 112, 114, and 110 to join an audio conference as follows.

1. Method of connecting to a web conference server 104 and transmit and receive voice data to and from an audio conference server 102 through a bridge session

2. Method of directly connecting to the audio conference server 102 using a SIP-based VoIP client

3. Method of directly connecting to the audio conference server 102 through a PSTN network

In the present embodiment, general participant terminals 108, 110, 114, and 116 may participate in an audio conference by selecting one of the above-described methods 1 to 3 according to need or a network status and the network connection ability of the terminals. However, terminal C 112, which is a host terminal, may be configured to directly connect to the audio conference server 102 under any circumstances using only the methods 2 and 3, except the method 1. For example, as illustrated in FIG. 5, when terminal A 108, terminal B 110, and terminal C 112 are able to access the Internet network, terminal A 108 and terminal B 110 may connect to the web conference server 104 or connect to the audio conference server 102 using a VoIP client. However, terminal C 112 is limited in direct connection to the web conference server 104 and may participate in the audio conference by connecting to the audio conference server 102 using a VoIP client.

To this end, the conference participant terminals 108, 110, 112, 114, and 116 each provide a user interface through which a user can join the audio conference using the methods 1 to 3, and in the case of the host terminal 112, a user interface which allows only the methods 2 and 3 to be selected is provided. For example, three types of connection buttons may be displayed on the general user terminals 108, 110, 114, and 116, and only two types of connection buttons may be displayed on the host terminal 112. Alternatively, the conference participant terminals 108, 110, 112, 114, and 116 may be configured to display all connection buttons associated with the methods 1 to 3 regardless of whether the corresponding terminal is a host terminal, and in the case of a host terminal, the terminal may be configured to directly connect to the audio conference server 102 autonomously using the method 2 even when the user selects the method 1.

In another embodiment, when the web conference server 104 receives an audio conference connection request from the host terminal 112 through the method 1, the web conference server 104 may be configured to transmit a redirection message for reconnection to the audio conference server to the host terminal 112. In this case, the host terminal 112 which has received the redirection message may directly connect to the audio conference server 102 using the method 2 or 3.

According to the present embodiment, the host terminal 112 may proceed with the audio conference while freely moving between the Internet and the PSTN network without creating an additional bridge session in the bridge server 106, and in this process, the connection status of other terminals connected to the web conference server 104 is not affected.

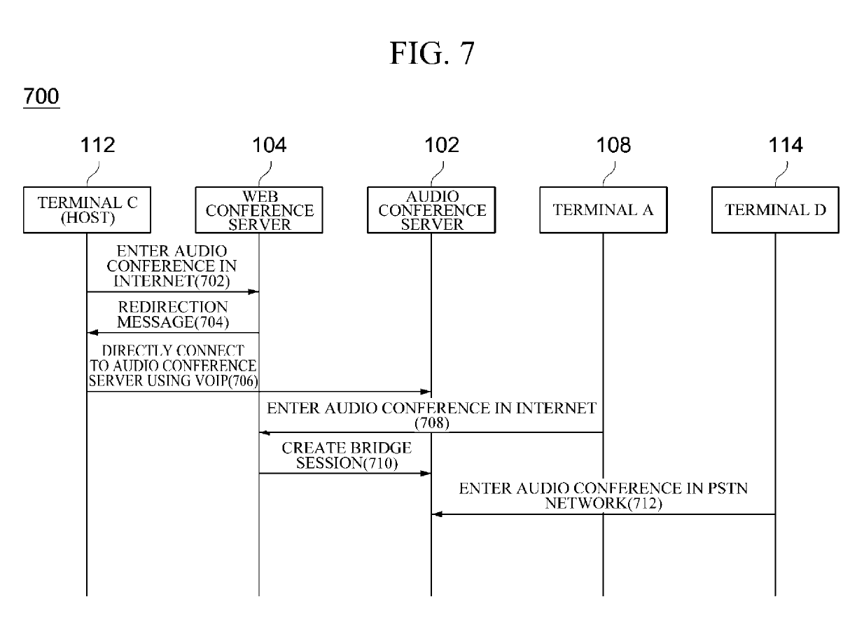

FIG. 7 is a flowchart for describing a method 700 for a host terminal to connect to an audio conference in a conference system 100 according to another embodiment of the present disclosure. In the illustrated flowchart, the method is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

In operation 702, terminal C 112 serving as a host terminal issues an audio conference connection request to a web conference server 104 in a packet network.

In operation 704, the web conference server 104 transmits a redirection message to terminal C 112.

In operation 706, terminal C 112 receives the redirection message and directly connects an audio conference server 102 using VoIP.

Meanwhile, in operation 708, terminal A 108, which is a general participant terminal, issues an audio conference connection request to the web conference server 104 in the packet network.

In operation 710, the web conference server 104 creates a bridge session 202 in a bridge server 106. The bridge session 202 is for audio data transmission/reception between terminal A 108 and the audio conference server 102.

Meanwhile, in operation 712, the audio conference server 102 receives an audio conference connection request from terminal D 114, which is a PSTN terminal, and processes an audio conference connection of the corresponding terminal.

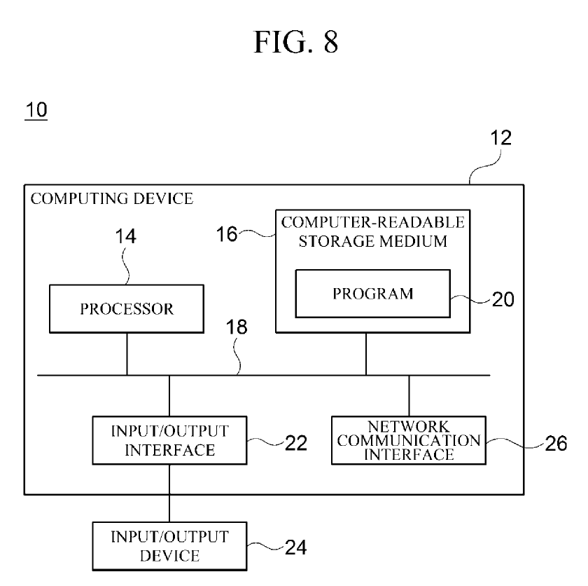

FIG. 8 is a block diagram for describing an example of a computing environment 10 including a computing device suitable to be used in exemplary embodiments. In the illustrated embodiment, each of the components may have functions and capabilities different from those described hereinafter and additional components may be included in addition to the components described herein.

The illustrated computing environment 10 includes a computing device 12. In one embodiment, the computing device 12 may be an audio conference server 102. In addition, the computing device 12 may be a web conference server 104, a host terminal 106 or at least one general conferee terminal 108. The computing device 12 may include at least one processor 14, a computer-readable storage medium 16, and a communication bus 18. The processor 14 may cause the computing device 12 to operate according to the aforementioned exemplary embodiment. For example, the processor 14 may execute one or more programs stored in the computer-readable storage medium 16. The one or more programs may include one or more computer executable commands, and the computer executable commands may be configured to, when executed by the processor 14, cause the computing device 12 to perform operations according to the illustrative embodiment.

The computer-readable storage medium 16 is configured to store computer executable commands and program codes, program data and/or information in other suitable forms. The programs stored in the computer-readable storage medium 16 may include a set of commands executable by the processor 14. In one embodiment, the computer-readable storage medium 16 may be a memory (volatile memory, such as random access memory (RAM), non-volatile memory, or a combination thereof) one or more magnetic disk storage devices, optical disk storage devices, flash memory devices, storage media in other forms capable of being accessed by the computing device 12 and storing desired information, or a combination thereof.

The communication bus 18 connects various other components of the computing device 12 including the processor 14 and the computer-readable storage medium 16.

The computing device 12 may include one or more input/output interfaces 22 for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. The illustrative input/output device 24 may be a pointing device (a mouse, a track pad, or the like), a keyboard, a touch input device (a touch pad, a touch screen, or the like), an input device, such as a voice or sound input device, various types of sensor devices, and/or a photographing device, and/or an output device, such as a display device, a printer, a speaker, and/or a network card. The illustrative input/output device 24 which is one component constituting the computing device 12 may be included inside the computing device 12 or may be configured as a separate device from the computing device 12 and connected to the computing device 12.

According to the disclosed embodiments, even when a host of an audio conference reconnects to the audio conference in a PSTN network after connecting to the audio conference through a web conference and a bridge server using a VoIP method, general participants who have joined the audio conference using the VoIP method are allowed to continue the audio conference without any influence, such as loss of connection to the audio conference.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A conference system comprising:
an audio conference server configured to relay an audio conference between a plurality of terminals; and
a web conference server configured to receive a request of a host terminal for connection to the audio conference and create a first bridge session for audio data transmission/reception between the host terminal and the audio conference server and a second bridge session for maintaining a host connection of the host terminal.

2. The conference system of claim 1, wherein when the web conference server receives a request for connection to the audio conference from a general participant terminal, the web conference server transmits respective audio data of the host terminal and the general participant terminal connected to the web conference server to the audio conference server via the first bridge session.

3. The conference system of claim 2, wherein the web conference server transmits audio data received from the audio conference server via the first bridge session to the host terminal and the general participant terminal.

4. The conference system of claim 1, wherein when the audio conference server receives a request for reconnection to the audio conference from the host terminal through a telephone network, the audio conference server terminates a connection to the second bridge session.

5. A web conference server which is connected to an audio conference server that relays an audio conference between a plurality of terminals, the web conference server comprising:
a receiver configured to receive a request of a host terminal for connection to an audio conference;
a bridge session creator configured to create a first bridge session for audio data transmission/reception between the host terminal and the audio conference server and a second bridge session for maintaining a host connection of the host terminal according to the request; and
a data transceiver configured to transmit and receive audio data between the host terminal and the audio conference server through the first bridge session.

6. The web conference server of claim 5, wherein when the receiver receives a request for connection to the audio conference from a general participant terminal, the data transceiver transmits respective audio data of the host terminal and the general participant terminal to the audio conference server via the first bridge session.

7. The web conference server of claim 6, wherein the data transceiver transmits audio data received from the audio conference server via the first bridge session to the host terminal and the general participant terminal.

8. The web conference server of claim 5, wherein when the host terminal reconnects to the audio conference server through a telephone network, the second bridge session is terminated.

9. A method for providing a conference service, comprising:
receiving, at a web conference server, a request of a host terminal for connection to an audio conference; and
creating, at the web conference server, a first bridge session for audio data transmission/reception between the host terminal and an audio conference server in which the audio conference is established and a second bridge session for maintaining a host connection of the host terminal.

10. The method of claim 9, wherein when the web conference server receives a request for connection to the audio conference from a general participant terminal, the web conference server transmits respective audio data of the host terminal and the general participant terminal to the audio conference server via the first bridge session and transmits audio data received from the audio conference server via the first bridge session to the host terminal and the general participant terminal.

11. The method of claim 9, further comprising, after creating the first and second bridge sessions,
receiving, at the audio conference server, a request for reconnection to the audio conference from the host terminal through a telephone network; and
terminating, at the audio conference server, a connection to the second bridge session.

12. A conference system comprising:
an audio conference server configured to relay an audio conference between a plurality of terminals; and
a web conference server configured to create a bridge session for audio data transmission/reception with the audio conference in cooperation with the audio conference server,
wherein when the web conference server receives a request of a host terminal for connection to an audio conference, the web conference server transmits a redirection message for reconnection to the audio conference server to the host terminal.

13. The conference system of claim 12, wherein when the web conference server receives a request for connection to the audio conference from a general participant terminal, the web conference server transmits audio data of the general participant terminal to the audio conference server via the bridge session and transmits audio data received from the audio conference server via the bridge session to the general participant terminal.

14. A method for providing a conference service, which is performed by a web conference server that creates a bridge session for audio data transmission/reception with an audio conference in cooperation with an audio conference server which relays the audio conference between a plurality of terminals, the method comprising:
receiving a request of a host terminal for connection to the audio conference; and
transmitting a redirection message for reconnection to the audio conference server to the host terminal.

15. The method of claim 14, wherein when the web conference server receives a request for connection to the audio conference from a general participant terminal, the web conference server transmits audio data of the general participant terminal to the audio conference server via the bridge session and transmits audio data received from the audio conference server via the bridge session to the general participant terminal.
